(19) United States
(12) Patent Application Publication
(10) Pub. No.: US 2017/0000247 A1
(43) Pub. Date: Jan. 5, 2017

(54) CARD WITH EMBEDDED TOOLS

(71) Applicants: Eitam Scharf, Los Angeles, CA (US); Iftach Scharf, Rishon Lezion (IL)

(72) Inventors: Eitam Scharf, Los Angeles, CA (US); Iftach Scharf, Rishon Lezion (IL)

(21) Appl. No.: 15/201,314

(22) Filed: Jul. 1, 2016

Related U.S. Application Data
(60) Provisional application No. 62/188,206, filed on Jul. 2, 2015.

(51) Int. Cl. A45F 5/00; B65D 73/00; A47J 43/25

(52) U.S. Cl. CPC A45F 5/00; A47J 43/25; B65D 73/0035

(57) ABSTRACT

A tool storage and carrying system for storing and carrying a variety of small flattened hand tools used for working with herbs and similar food or plant material includes a thin rigid sheet with specially configured recesses on a surface of the sheet for accommodating the placement of individual tools, the tools being removably held in the recesses in a variety of different ways including magnetic attachment, pressure fit and sliding engagement. The sheet can be optionally extended to include a grinding area formed by a plurality of grooves, and also can include an optional removable cover.

### CROSS-REFERENCES TO RELATED APPLICATIONS

This application claims the benefit of U.S. Provisional Application No. 62/188,206, filed Jul. 2, 2015, which is incorporated by reference in its entirety.

### BACKGROUND

This invention relates generally to tool storage and carrying systems, and more particularly has reference to a compact device for detachably storing and carrying a variety of small hand tools especially adapted for working with herbs and similar food or plant materials, and which also has the option of including an abrading device for grinding the food and plant material to a fine mulch or particulate form suitable for ingestion and other uses.

Hand tools and utensils for working with herbs and similar food or plant materials are well known. However, most such tools are relatively large and intended to be stored in a drawer or countertop holder. The tools are normally carried by hand when moved from place-to-place.

Grinders for rendering food and plant material to a mulch or particulate form also are known. However, motor-driven grinders are usually large and not easy to carry from place-to-place, while smaller manual grinders often have sharp cutting blades which pose a safety hazard and can be dangerous to use or carry around.

The recent development of the grinder card, described in my previous U.S. Pat. Nos. 8,636,237; 8,672,249; and 8,882,010, entitled “Herb Grinder,” was a major advance. It overcame many of the problems associated with existing manual and motor-driven grinders by providing a small compact grinder which is simple in structure and easy to use, which is capable of grinding herbs and similar food or plant material safely and efficiently, and which can be easily carried around in a shirt pocket or wallet or suspended by a chain around the user's neck.

However, a need still exists for a new type of tool storage device which is compact and easy to carry and use, and which can be integrated with the Herb Grinder if desired.

The present invention fulfills those needs.

### SUMMARY OF THE INVENTION

Briefly, and in general terms, the present invention provides a new type of tool storage and carrying system for compactly and safely storing a variety of small hand tools used for working with herbs and similar food or plant materials, and which can easily be carried in a briefcase, handbag, cell phone carrier, business card holder, wallet, or shirt pocket, or suspended by a chain around the user's neck. The system is relatively inexpensive and easy to manufacture, is reliable and easy to carry and use, and can be integrated with the afore-mentioned Herb Grinder.

In a preferred form, the invention is embodied in a thin sheet with a novel configuration of surface recesses for accommodating the placement of individual hand tools that can be detachably removed from the sheet. Each recess is configured to conform to the shape of the tool it accommodates. Each of the tools preferably has a thin flattened shape and lies in the plane of the sheet flush with the surface when placed in the recess. Each recess also can be provided with a finger access area to facilitate removing the tools from the sheet more easily. The recesses can be formed on the front or the back surface of the sheet, depending upon the particular application.

The tools can be secured in the recesses in a variety of different ways, including magnetic attachment, pressure fit, or sliding engagement. Each method has its own unique features. For a magnetic fit, either the tool or the sheet is made out of ferromagnetic material, while the mating part is magnetized or carries a small magnet. For a pressure fit, either a resilient sleeve is added onto the tool or a resilient frame is attached to the inside perimeter of the recess, allowing the tool to be tucked into the recess with downward pressure, or alternatively, the entire sheet can be made out of rubber, plastic, or other resilient material to serve the same purpose as the resilient frame. For a sliding engagement, the recess is provided with an opening at the end of the sheet to allow the tool to slide into and out of the recess, and either the tool or the recess has slots for slidably receiving flanges on the sides of the mating part.

The sheet is preferably made out of rigid material such as metal or plastic depending on the purpose for which the product is intended, although a solid metal material is preferred. The front and back surfaces of the sheet are preferably flat and smooth.

The sheet can be made in a wide range of sizes and shapes to meet specific needs and intended uses. The sheet can be rectangular, round, oval, or other regular or irregular shape. In a preferred form, the sheet is rectangular and about the size of a credit card, which is ideal for carrying in a shirt pocket, wallet, or cell phone carrier. In an alternative embodiment the sheet is round or triangular and designed to be hung by a chain around the user's neck. The tools are flattened and miniaturized to fit on the sheet. Preferably, the tools are flattened with a thin preferably rectangular shape in elevation and cross section, equal to or slightly less in thickness than the depth of the recess, so that the outer surface of the tools are substantially flush with the surface of the sheet when the tools are placed in the recesses. The recesses preferably have a mating cross-sectional shape.

The sheet can be optionally extended at the top or bottom or sides to include a grinder/grater feature. The grinder can have a variety of different configurations, but preferably is formed by one of the novel groove patterns described in my earlier patent on the Herb Grinder, including a plurality of through-holes distributed in the grooves and/or on the adjacent surfaces of the sheet. When the grinding area is formed by one of the special groove patterns as described in one of my previous patents, it is safer and easier to use because it does not require cutting blades on the surface that could cut the user's fingers during use or damage material when placed into a shirt pocket, wallet, or other carrier. A grinder made in accordance with any of my previous patents also is particularly suitable for use in grinding soft herbs, spices, fruits, nuts, tobacco and other material.

The recesses can be formed on the front or back surface of the sheet. When the sheet is in the form of a card, the recesses are preferably formed on the front surface of the sheet, and the back surface is left blank, printed with instructions on how to use the card, or printed, etched or engraved with a design or other surface decoration. When the sheet is to be hung by a chain around the user's neck, the recesses are preferably formed on the back surface of the sheet (in this case the side facing the user's body), and the front surface is printed with a design or other ornamental feature.

An optional cover made of food grade silicone or other flexible material can be fitted onto either side of the sheet to protect the printed design or to cover the tools and prevent any material residue from falling out of the tools while in transit.

These and other features and advantages of the invention will become more apparent from the following detailed description, taken in conjunction with the accompanying drawings which illustrate, by way of example, features of the present invention.

### BRIEF DESCRIPTION OF THE DRAWINGS

FIG. 1 is a front perspective view of a tool storage and carrying system embodying novel features of the present invention, and showing one of the tools removed from the card and three of the tools in place.

FIG. 2 is a front plan view of the system shown in FIG. 1 with all of the tools removed from the card.

FIG. 3 is a rear plan view of the system shown in FIGS. 1-2.

FIG. 4 is an enlarged cross-sectional view, taken substantially along the line 4-4 of FIG. 2.

FIG. 5 is an enlarged side elevational view of one of the tools shown in FIG. 1.

FIG. 6 is an enlarged, fragmentary view of the central handle portion of one of the tools shown in FIG. 1, with a rubber sleeve for attaching the tool to the card.

FIG. 7 is an enlarged, fragmentary view of the central handle portion of one of the tools shown in FIG. 1, with a magnet for attaching the tool to the card.

FIG. 8 is an enlarged, fragmentary view of the central handle portion of one of the tools shown in FIG. 1, with flanges for attaching the tool to the card.

FIG. 9 is a front plan view of another embodiment of the invention which is especially useful with the tool shown in FIG. 8, and having openings at the end of the card to allow the tools to slide into and out of the recesses.

FIG. 10 is a bottom end view of the card shown in FIG. 9.

FIG. 11 is an enlarged, fragmentary cross-sectional view, taken substantially along the line 11-11 of FIG. 9.

FIG. 12 is a plan view of one of the tools shown in FIG. 1.

FIG. 13 is a plan view of another one of the tools shown in FIG. 1.

FIG. 14 is a plan view of yet another one of the tools shown in FIG. 1.

FIG. 15 is a plan view of still another one of the tools shown in FIG. 1.

FIG. 16 is a plan view of an alternative tool.

FIG. 17 is a plan view of yet another alternative tool.

FIG. 18 is a plan view of still another alternative tool.

FIG. 19 is front perspective view of another embodiment of the invention, showing an alternative groove pattern in the grinding area.

FIG. 20 is an enlarged, fragmentary sectional view taken substantially along the line 20-20 of FIG. 19.

FIG. 21 is a front plan view of yet another embodiment of the invention, showing yet another groove pattern in the grinding area.

FIG. 22 is a front plan view of still another embodiment of the invention, showing still another groove pattern in the grinding area.

FIG. 23 is a rear plan view of a cover used with the card shown in FIGS. 1-3.

FIG. 24 is a sectional view taken substantially along the line 24-24 of FIG. 23.

FIG. 25 is a rear plan view of an alternative embodiment of the invention, with a triangular-shaped sheet hanging from a chain.

### DETAILED DESCRIPTION OF THE PREFERRED EMBODIMENTS

As shown in the drawings for purposes of illustration, the invention is embodied in a thin sheet 10 especially adapted for carrying small flattened hand tools 12 used for working with herbs and similar food or plant material.

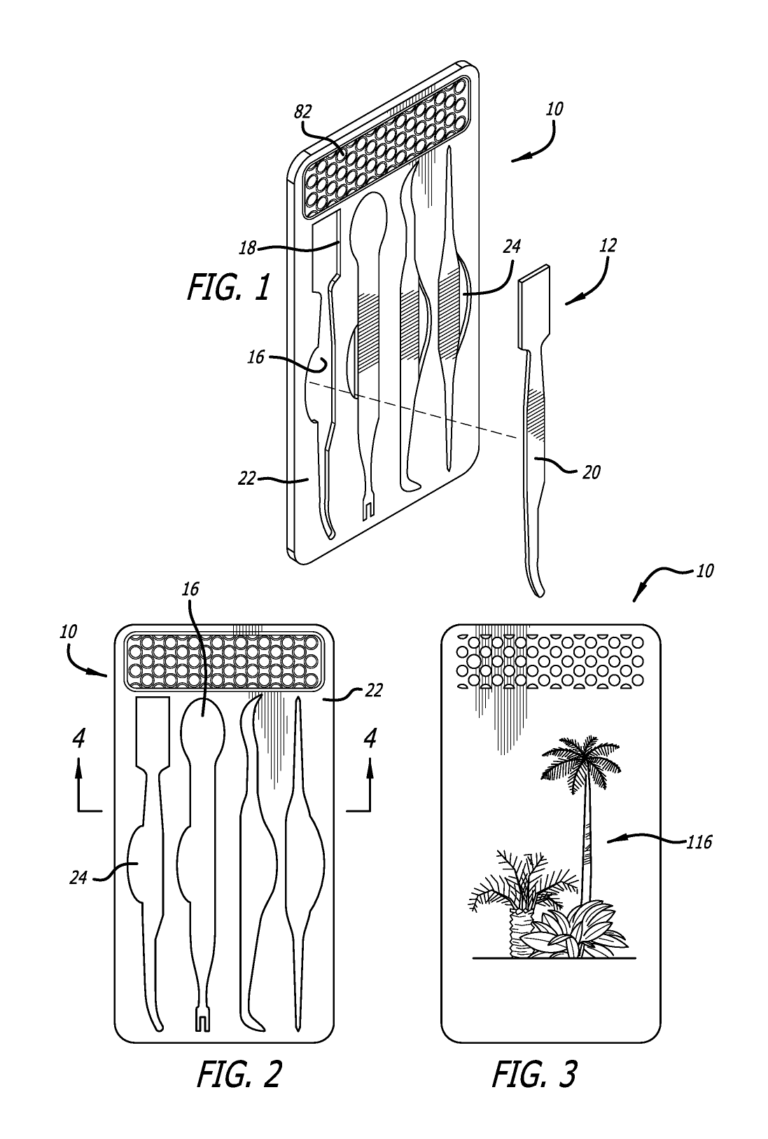

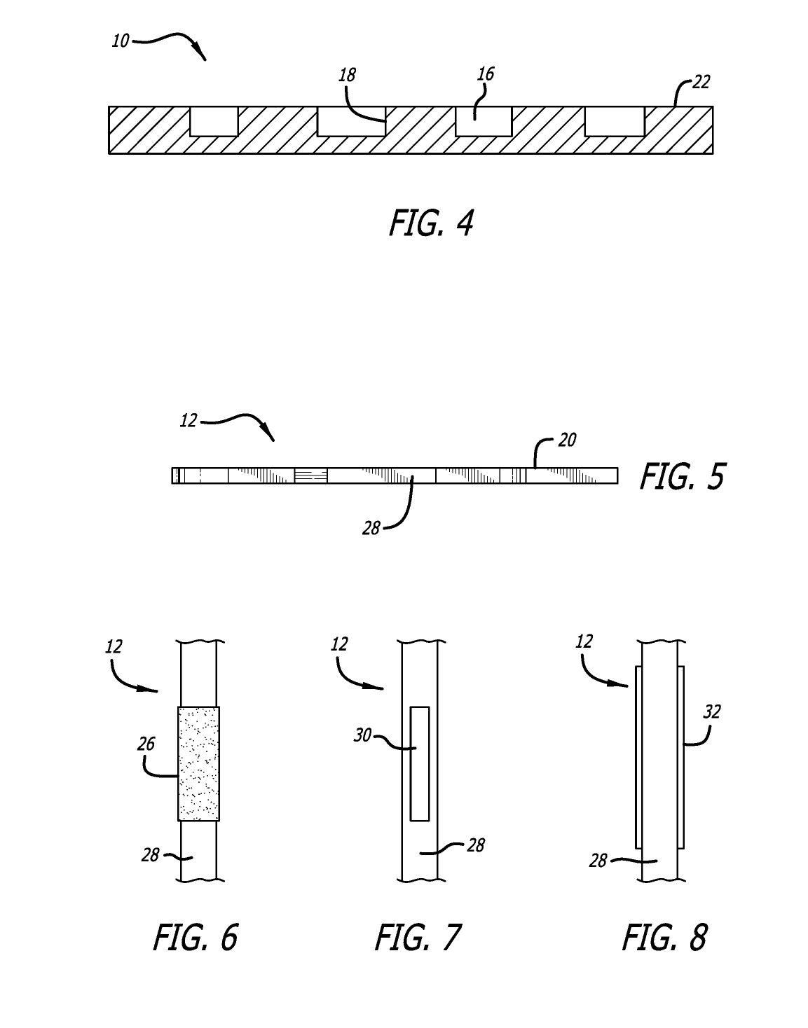

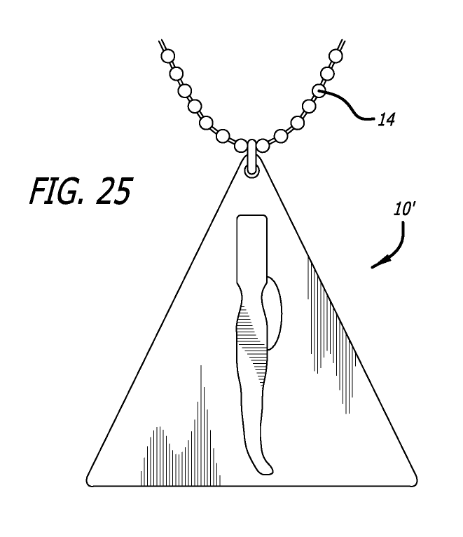

The sheet can have a variety of different sizes and shapes depending on the specific application. The sheet can range in thickness from about 1.0-2.5 millimeters. In a preferred embodiment, as shown in FIGS. 1-3, the sheet is in the form of a thin rectangular sheet, preferably about 1.3-1.5 millimeters thick and more preferably about 1.43 mm thick, and approximately the size and shape of a typical credit card, i.e., about 2 inches wide by about 3.5 inches long, which can easily fit into a wallet, shirt pocket, or cell phone carrier. In an alternative embodiment as shown in FIG. 25, the sheet 10′ is smaller and triangular in shape, but comparable in thickness, and made to resemble a medallion to be hung by a chain 14 around a user's neck. In either case, the sheet can be made out of various materials including metal, plastic or rubber depending on the purpose for which the sheet is intended, although metal is preferred for most applications.

In accordance with the present invention, the sheet is provided with a novel configuration of recesses 16 on the front or rear face to detachably hold a variety of small flattened hand tools. Each recess is elongated and is generally configured to match in plan and in section the size and shape of the tool it is intended to hold with a small clearance. Once the tool is placed into the recess, it is substantially restrained against lateral movement by the walls 18 of the recess. The depth of the recess is preferably equal to or slightly greater than the thickness of the tool it is intended to hold, so that the outer surface 20 of the tool is essentially flush with the face 22 of the sheet when the tool (and its associated attachment mechanism) is fit into the recess. The depth of each recess is preferably about 0.9 millimeters or about 60-70% of the thickness of the sheet, whereas the typical tool is preferably about 0.8 millimeters thick with a width-to-thickness aspect ratio of about 6:1 to 20:1 at the widest point.

In a preferred embodiment, each recess 16 is provided with a small lateral finger access area 24 extending from a central part of the recess for accommodating a user's fingertip for gripping the tool and removing the tool more easily from the recess. The finger access area of the recess is preferably semi-circular or half oval in shape, as shown in FIG. 1.

The tool can be removably held in the recess in a variety of different ways.

In one embodiment, as shown in FIG. 6, a resilient sleeve 26 made of rubber or similar material with a slightly enlarged outside diameter is attached to a central portion 28 of the tool 12. The external width of the sleeve is slightly greater than the internal width of the recess into which the tool is to be placed, resulting in an interference fit, and allowing the tool to be press fit into the corresponding recess with downward pressure. Alternatively, a resilient frame (not shown) is attached to the walls 18 of the recess 16 in lieu of the sleeve to hold the tool in place with a pressure fit. In yet another embodiment, the entire sheet is made out of rubber, plastic or other flexible material, and each recess is slightly undersized to allow the tool to be pressed into place.

In an alternative embodiment, as shown in FIG. 7, a small magnet 30 is attached to the back of the tool 12 in the central portion thereof 28, and the sheet is made out of ferromagnetic material, allowing the tool to be held in the recess by magnetic attraction. Instead of attaching the magnet to the tool, the magnet can be attached to the bottom of the recess. Alternatively, both the tool and the magnet can be made out of ferromagnetic material, and one of the parts can be magnetized to hold the tool in the recess. While ferromagnetic material is preferred when the magnetic attachment is used, if the pressure fit attachment of FIG. 6 (or an alternative form of attachment) is used instead, then the sheet and the tool can be made from any type of steel or other material.

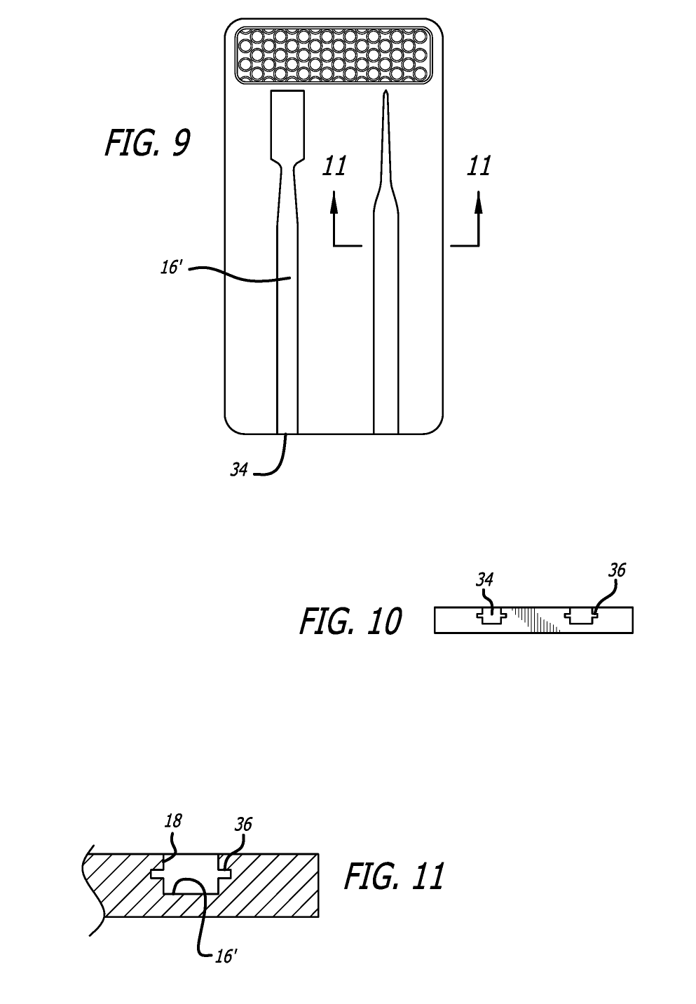

In yet another embodiment, as shown in FIG. 8, a long thin ridge or flange 32 is provided on each side of the tool 12 in a central portion thereof 28 to hold the tool in the recess. The flange extends laterally from opposite sides of the tool in the central shaft region thereof. For this embodiment, each of the recesses 16′ is provided with an opening 34 at the end of the sheet as shown in FIGS. 9 and 10, and the tool is slid into and out of the recess through the opening. Because the tool is placed into and removed from the recess by a sliding action, a finger access area is not required in the recess. The flanges on the tool are slidably received in slots or grooves 36 cut along the sidewalls 18 of the recesses as shown in FIG. 11. The flanges project a little less than the depth of the slots. The slots hold the flanges (and thus the tool) in place in the recess with a tongue and groove type joint. Preferably, an interference fit is provided between the flanges and the slots to hold the tool in place even when the sheet is held upright with the openings facing down. The flanges and slots can be reversed, so that the flanges are provided on the walls of the recesses and the corresponding slots are provided on the sides of the tools, if desired. Use of the flanges for attaching the tools is particularly suited for tools in which the central portion 28 is either as wide or wider than the working ends of the tool. The opening 34 at the end of the recess is made to be as wide as the widest part of the tool.

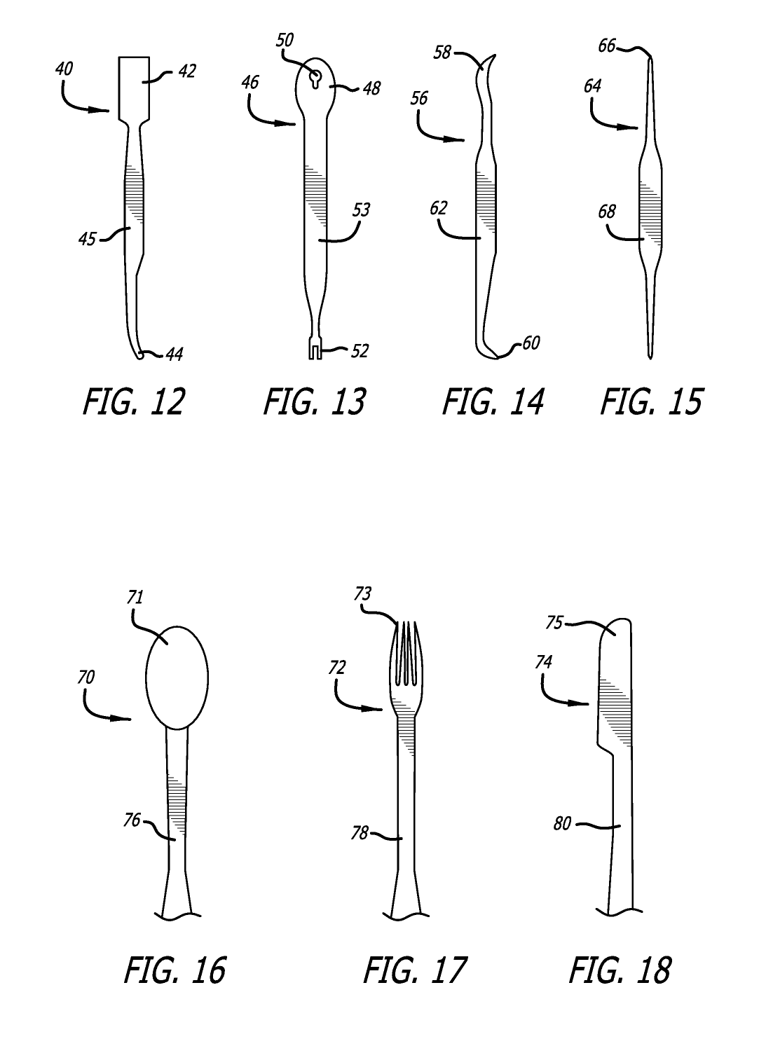

A variety of different tools can be used. Some examples are shown in FIGS. 12-18.

FIG. 12 shows a sculpting and packing tool 40 with two different ends. One end has a flat rectangular scraper blade 42 for collecting and packing ground material, while the opposite end has a thin-angled poker 44 for cleaning grooves and holes in the optional grinding surface and for reaching into small areas. The two ends are joined by a central handle portion 45 used to grip the tool when in use.

FIG. 13 shows a spork-type hardware tool 46 with two different ends. One end is a spoon-like tip 48 with a hole 50 in the middle for handling larger chunks of ground material while allowing heat to pass through, while the opposite end is a small fork 52 for handling slippery material. The two ends are joined by a central handle portion 54.

FIG. 14 shows a dental-type scraper tool 56 with angled hooks 58 and pointed tips 60 at each end, and a central-handle portion 62. The tool can be used for scraping material and accessing hard-to-reach areas.

FIG. 15 shows a precision poker tool 64 with pointed tips 66 at each end and a central-handle portion 68. One end preferably has a skinny tip, while the opposite end has a medium tip. The tool is useful for poking and cleaning purposes.

FIGS. 16-18 show a spoon 70, fork 72, and knife 74, respectively. Each tool has a working end 71, 73, and 75, respectively, and an elongated handle portion 76, 78, 80, respectively.

Although the tools can be made in a variety of different sizes, each of the tools shown in FIGS. 12-18 is preferably about 3 inches long and about ¼ to ¾ inches wide at its widest point, with an elongated shaft/handle portion, and a work piece at one or both ends. The tools can be made out of various materials including metal or plastic, but stainless steel is preferred. It is preferred that each of the tools has a thin rectangular shape when viewed in elevation, as shown in FIG. 5, and a thin rectangular cross-sectional shape. When viewed in plan, it is preferred that the shape of the tool at the working end and handle portion conforms to the shape of the corresponding recess with a small clearance between the two to allow for the tool to be placed into the recess. The recess preferably has a cross sectional shape which mates with the cross sectional shape of the tool it is intended to accommodate.

The sheet can be optionally extended at one end to include a grinding area 82, as shown in FIGS. 1-3. While FIGS. 1-3 show the grinding area at the top end of the card, it will be appreciated that the card can be extended to accommodate a grinding area at the bottom end or along the sides of the card, if desired.

The grinding area can be formed in a variety of different ways, but preferably is formed by one or more of the novel groove patterns described in my previous patents U.S. Pat. No. 8,636,273; 8,672,249; and 8,882,010, each of which is incorporated herein by reference in its entirety. These groove patterns have the advantage of providing a grinding surface which is safe and easy to use because it does not require cutting blades on the surface of the card that could cut the user's fingers during use or damage material when placed into a shirt pocket, wallet, or other carrier. Such a grinding pattern also is particularly suitable for use in grinding soft herbs, spices, fruits, nuts, tobacco, and other food or plant materials. The grinding surface is preferably formed on the same face of the card as the tool-holding recesses.

The grinding area can be configured in a variety of different ways.

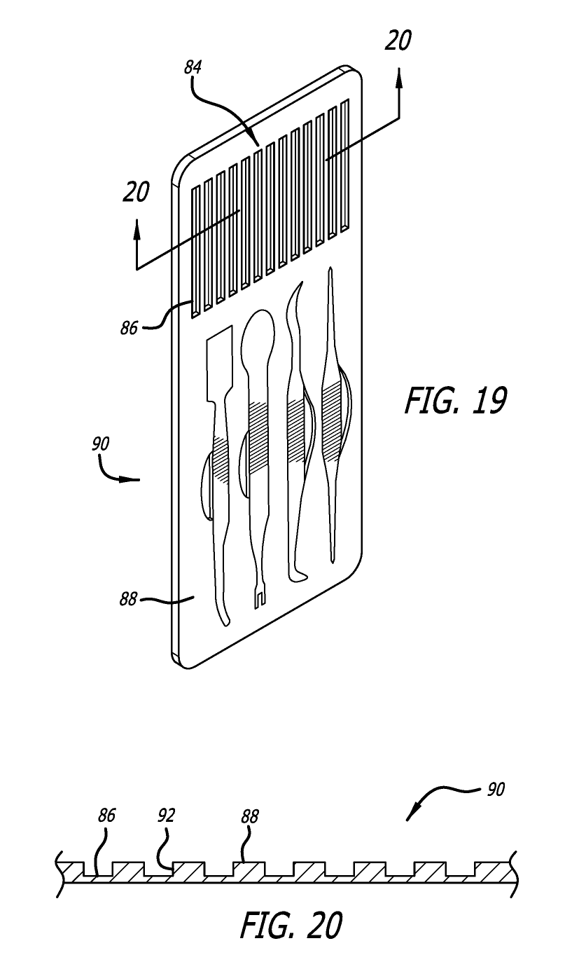

Referring to FIGS. 19-20, the grinding area 84 is formed by a plurality of grooves 86. The grooves in this particular embodiment comprise a series of straight, spaced-apart, parallel notches or channels of elongated rectangular shape formed into at least the front surface 88 of the sheet 90 near the top end thereof, and extending vertically across a portion of the surface. FIG. 20 shows the profile of the sheet of FIG. 19, illustrating the difference between the grooves 86 and the adjacent surface 88 of the sheet 90. The particular size, shape, and arrangement of the grooves can vary, as will be later explained, and are selected so as to provide a desired grating area on the surface of the sheet.

As previously noted, the grinding area shown in FIGS. 19-20 does not have any sharp edges or cutting blades sticking out of the grinding surface that could cut a user's fingers or damage clothing or other material. Instead, the groove pattern forms the grinding area. The sidewalls 92 of the grooves provide a grinding action. The user's fingers are protected because those walls are not on the surface of the sheet. The grinding and cutting action occurs as the result of reciprocal two-way side-to-side motion of the material to be ground across the grinding surface.

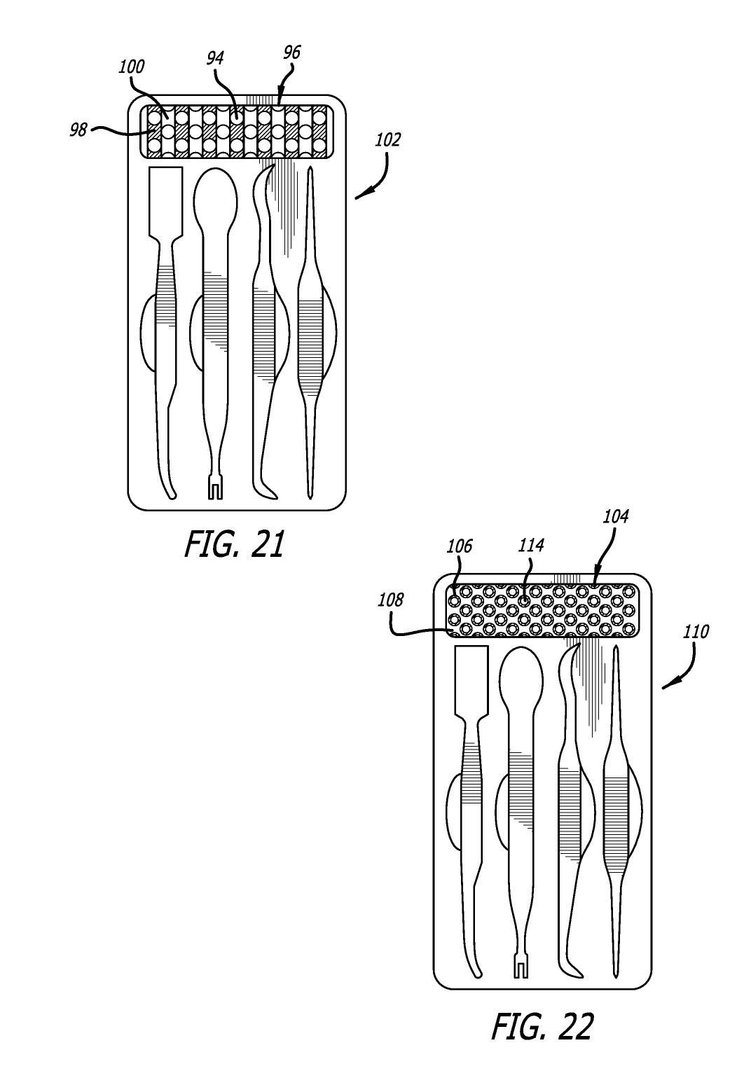

FIG. 21 shows an alternative embodiment in which a plurality of through holes 94 are provided in the grinding area 96. The holes are distributed in the grooves 98 and on the adjacent surfaces 100 of the sheet 102 in the spaces between the grooves. The holes perform both a grinding and cutting function. They add additional cutting edges to the grinder which makes it more efficient. The holes can vary in size, location, concentration, and spacing. In order to better illustrate the difference between the grooves and the adjacent surfaces of the sheet, the grooves have been illustrated with a hatching pattern in FIG. 21 to distinguish between the grooves and the adjacent spaces on the surface of the sheet.

FIG. 22 shows another alternative embodiment of the grinding area 104, in which each of the grooves 106 has a circular shape, and the grooves are arranged in staggered rows of spaced-apart grooves extending across the grinding area. In order to better illustrate the difference between the grooves and the adjacent surfaces 108 of the sheet 110 in the spaces between the grooves, the grooves have been illustrated with a hatching pattern in FIG. 22 to distinguish between the grooves and the adjacent spaces between the grooves. In addition, a through hole 114 is provided in each of the circular grooves. The diameter of the hole is preferably smaller than the diameter of the circular groove, so that each hole is surrounded by an individual groove. The holes extend completely through the card. The holes perform an additional grinding and cutting function. They also have the added advantage of eliminating waste bits from the grooves, thereby preventing waste accumulation that could adversely affect the grinding action.

It will be appreciated that the grooves can take on different shapes other than those shown in FIGS. 19-22, such as triangles, ovals, stars, or polygons, and can be hearts or even other irregular shapes, and combinations thereof. The size and shape of the grooves also can differ from groove-to-groove, and the grooves can be evenly or unevenly aligned. The grooves also can be arranged with alternate spaces in a checkerboard pattern.

In all of the embodiments mentioned above, the grooves are generally (but not necessarily) rectangular in cross-sectional shape with sidewalls that are preferably (but not necessarily) perpendicular to the flat surface of the sheet. The angle between the sidewall and the flat surface of the sheet can be either acute or obtuse. When the angle is acute the grinding edge protrudes more. The cutting efficiency is enhanced and the grinding effect is reduced. When the angle is obtuse, the cutting edge is more blunt. As a result, the grinding effect is enhanced, while the cutting effect is reduced.

The depth of the grooves is preferably between about 3-50% of the thickness of the sheet. A shallow-depth groove generally results in a grinding area which can grind to a more fine texture. The diameter of the holes is typically about 1-8 millimeters, with the diameter of the circular groove being about 10-15 millimeters.

The grooves can be formed in many different ways, such as by a CNC machine, mold-stamping, laser-cutting, or water jetting. Another option is to use mask chemical erosion which causes the groove to be rough, which can enhance the grinding effect. The holes can be formed by stamping or punching or any other suitable means, and they can be formed in the card before or after the grooves have been formed. Similar methods also can be used to form the tool holding recesses on the surface of the sheet.

The recesses 16 can be formed on the front or back surface of the sheet, as desired. In either case, the opposite surface may be left blank, printed with instructions on how to use the sheet, or printed, etched, or engraved with a design or other surface decoration 116, as shown in FIG. 3. The design on the surface opposite the recesses can be full color or spot color. A design is particularly useful with an embodiment like the one shown in FIG. 25, where the design side faces out away from the user's body, giving the appearance of a decorative medallion hanging around the user's neck, with the tools facing rearwardly toward the user's body substantially out of view.

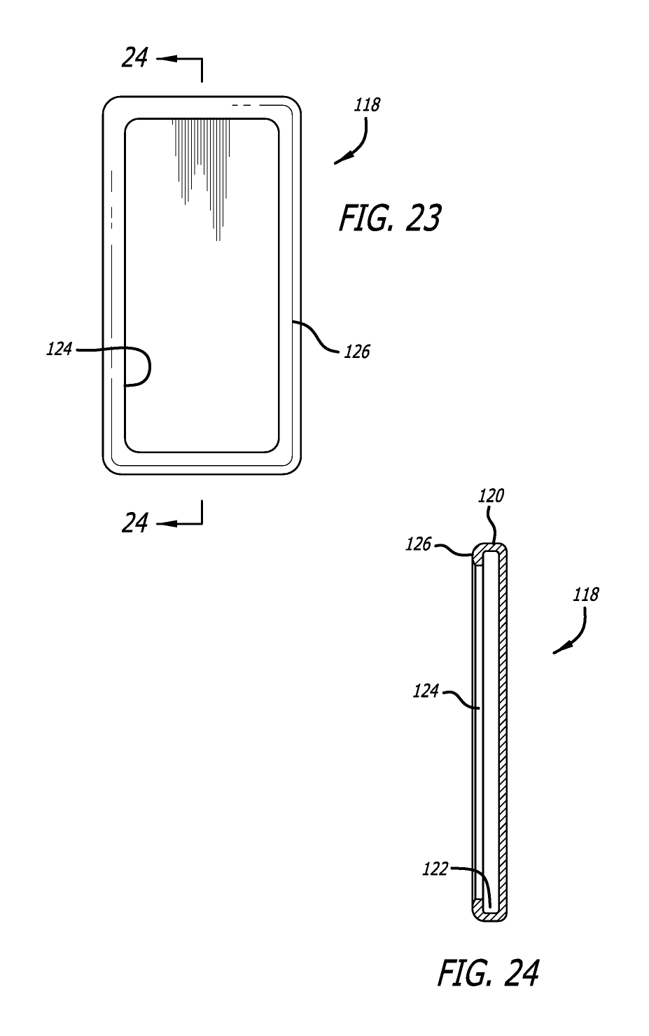

An optional removable cover 118 made of food grade silicone or other flexible material can be fitted onto the front or back side of the sheet to protect the printed design, to cover the tools for protection and storage, and to prevent any material residue from falling out of the tools while in transit. As shown in FIGS. 23-24, the cover preferably has a rectangular or other shape conforming to the shape of the sheet to be covered, with four sides 120 defining an inward facing groove 122 along the perimeter which fits over the edges of the sheet to hold the cover on the sheet. The cover conceals one face of the card, while leaving the opposite face exposed through an opening 124 bounded by the sides of the cover. Raised edges 126 surround the opening to protect the sheet when placed face down on the table or other surface. When the cover is used to conceal the face of the sheet holding the tools, the cover will provide extra security in keeping the tools in place on the sheet. The cover is lightweight, durable, soft to the touch, and provides impact resistance for the sheet.

From the foregoing, it will be appreciated that the tool storage and carrying system of the present invention allows a variety of small hand tools to be compactly and securely stored and carried on a card or sheet that can be carried in a shirt pocket, wallet, cell phone carrier, business card holder, briefcase, handbag, or suspended by a chain around the user's neck, that allows the tools to be easily removed from the card for use, and that optionally includes a grinder on the sheet.

While several particular forms of the invention have been illustrated and described it will be apparent that various modifications can be made without departing from the spirit and scope of the invention.

I claim:

1. A tool storage and carrying system, comprising:
a rigid sheet having a first surface and a second surface, the sheet being configured to include, on the first surface, one or more elongated recesses, each recess having a bottom and sidewalls defining in outline the shape of a tool to be placed in the recess;
one or more tools, each tool having a shaft portion and at least one working end conforming in shape to at least one of the recesses, the tool further having a flattened profile and a sectional shape, mating with the sectional shape of the recess; and
a connector for removably holding the tool in the recess.

2. The system of claim 1, wherein the connector comprises a magnet affixed to the tool for attaching the tool to the recess by magnetic attraction.

3. The system of claim 1, wherein the connector is a magnetic attachment, the recess and the tool being made out of ferromagnetic material, at least one of which is magnetized.

4. The system of claim 1, wherein the connector comprises a resilient sleeve disposed on the shaft portion of the tool, the sleeve being configured to engage the sidewalls of the recess within an interference fit when the tool is placed into the recess.

5. The system of claim 1, wherein the connector comprises a resilient frame disposed along the sidewalls of the recess, the frame being configured to provide an interference fit between the frame and the tool when the tool is placed in the recess.

6. The system of claim 1, wherein the recess and the tool are made out of resilient material and configured to provide an interference fit between the recess and the tool when the tool is placed into the recess.

7. The system of claim 1, wherein, the connector comprises flanges on the sides of the tool configured to engage slots in the sidewalls of the recess to hold the tool in the recess.

8. The system of claim 7, wherein an opening is provided at an end of the recess for slidably receiving the tool to allow the tool to slide into and out of the recess.

9. The system of claim 7, wherein the flanges and the slots are configured to provide an interference fit.

10. The system of claim 1, wherein the connector comprises flanges on the sidewalls of the recess that extend into the recess and are configured to engage slots in the shaft portion of the tool to hold the tool in the recess.

11. The system of claim 1, wherein the sheet has the size and shape of a credit card.

12. The system of claim 1, wherein the sheet is disposed on a chain configured to hang around a user's neck, and the second surface of the sheet is provided with decorative ornamentation.

13. The system of claim 1, wherein the sheet and the tools are made from a material selected from the group consisting of metal and plastic.

14. The system of claim 1, wherein the sheet and the tools are made from the same material.

15. The system of claim 1, wherein a finger access area is provided in the recess to facilitate removing the tool from the recess.

16. The system of claim 1, further comprising a cover made of resilient material conforming to the shape of the sheet, the cover having sides defining an inward facing groove along a perimeter of the cover for receiving edges of the sheet to hold the cover on the sheet.

17. The system of claim 1, wherein each of the tools has a flat outer surface that lies substantially in the plane of the sheet when the tool is lying in the recess.

18. The system of claim 1, further comprising a plurality of grooves on the surface of the sheet forming a grinding area.

19. The system of claim 18, wherein the grooves have an elongate rectangular shape and are arranged in parallel with each other, and a plurality of through holes are distributed in the grooves and on the surface of the sheet between the grooves.

20. The system of claim 18, wherein the grooves have a circular shape and are arranged in staggered rows of alternating grooves and spaces, and a plurality of through holes are distributed in the grooves.
